(19) United States
(12) Patent Application Publication
(10) Pub. No.: US 2003/0164973 A1
(43) Pub. Date: Sep. 4, 2003

(54) Printing method, broadcast data generation device, reception device and printing device

(76) Inventors: Kenji Hisatomi, Hirakata-shi (JP); Kazuyuki Murata, Kyotanabe-shi (JP); Hideyuki Kuwano, Hirakata-shi (JP); Jun?apos;ichi Kubota, Amagasaki-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/367,715

(22) Filed: Feb. 19, 2003

(30) Foreign Application Priority Data
Feb. 19, 2002 (JP) 2002-041424

(51) Int. Cl. G06F 15/00; B41J 1/00

(52) U.S. Cl. 358/1.15

(57) ABSTRACT

A printing method for printing image data in a system comprising: a reception device that receives image data distributed from outside and a printing device that prints the image data transmitted from the reception device, the printing method including: a image data acquisition step in which the reception device acquires first image data of a first image quality standard; a degradation step for converting the acquired first image data into a second image data of a second image quality standard that is inferior to the first image quality standard; and a print step in which the printing device prints the converted second image data.

### BACKGROUND OF THE INVENTION

(1) Field of the Invention

The present invention relates to a printing method, a broadcast data generation device, a reception device and a printing device (a printer) and particularly to a method and a device that display received image data by rendering on a video RAM in the device and provide the image data to the printing device and have the printing device print the image data.

(2) Description of the Prior Art

When image data that an STB (Set-Top Box) and a DTV (Digital TV) receive through a broadcast satellite and the like are displayed by a display device and the displayed screen is printed on a medium such as a paper by a printer, the image data are rendered temporarily in video RAM (Random Access Memory) with resolution that is compatible with the display device by a rendering engine built in the STB and the like. Then, the image data rendered in the video RAM are printed after processing that is compatible with the printer feature is executed. The case of printing an image displayed on TV by a video printer is a typical example of a mode like this.

On the other hand, in order that a user can reuse video contents of a digital TV that are prohibited to be recorded, technology that reduces the number of pixels and lowers resolution within a range in which the user can watch and hear is disclosed so that the user can record and reuse the video contents (the Japanese Laid-Open Patent Application No. H11-146378 (pp. 4-6, FIG. 1), for example).

However, with an increase in performance of a display device and a widespread use of a high-definition TV, if the image data rendered in the video RAM of the STB are printed with level quality of the display device, a fine printed material of the image data is generated, and therefore there is a problem that the result goes against the intention of an author that wants to manage production thoroughly.

Additionally, in the case of outputting high-quality image data from the STB or the like to the printer to be printed, if the image data are stolen during the transmission or high-quality image data without degradation processing are outputted from a device, the transmitter, the situation develops an irremediable infringement of a copyright.

Further, in the case of printing, even if the user tries to provide protection during the distribution, there is a fear that what is printed is copied by a high-quality color copier.

Furthermore, in the prior art, to reuse the video contents protected by the copyright (or prohibited to be recorded), description that degrades the video image quality are disclosed, but the description aims at lowering “the quality level of the video” principally based on the premise that the video contents are displayed on the same display device and therefore the quality level when the video contents are outputted to the printer that has the far higher resolution performance than a conventional display device is not supposed.

In other words, for contents protection on the printing, the extent to which printed image quality is degraded is an important requirement but contents creators cannot confirm or specify the extent to which degradation of the printed image quality is guaranteed, and as a result it is difficult for the contents creators to estimate the protection level of the copyright in advance.

Additionally, when digital TV broadcast is information source, as for screen display data, various kinds of information such as video part, still image part, text part and graphics part are dealt but the degree to protect the copyright is different according to the kind and the contents of each information source. But it is impossible to change control of the copyright in print control according to each information source. For example, there is a case that it is necessary to protect the copyright strongly of the still image part and the video part but it is desirable to do commentary freely.

Furthermore, there is a case that for the same kind of contents, the contests creator wants to decide the copyright control for the contents because of the contents creator's convenience, the prior art cannot respond to this. Further, there is a case that it is desirable to protect the copyright by controlling an image size because the image size may decide whether or not it is worthy of viewing but the prior art cannot respond to this.

To sum up, if the high-grade contents for a digital TV or the like distributed from outside are printed with the quality level of the display device without degradation, there is a problem that the result does not correspond to the intention of the author that wants to manage production thoroughly.

### SUMMARY OF THE INVENTION

In view of the foregoing, it is the object of the present invention to provide a printing method, a broadcast data generation device, a reception device and a printing device that can obtain the printed material that answers the intention of the author.

To achieve the above-mentioned object, the printed method according to the present invention is a printing method for printing image data in a system comprising: a reception device that receives image data distributed from outside and a printing device that prints the image data transmitted from the reception device, the printing method including: a image data acquisition step in which the reception device acquires first image data of a first image quality standard; a degradation step for converting the acquired first image data into a second image data of a second image quality standard that is inferior to the first image quality standard; and a print step in which the printing device prints the converted second image data.

Hereby, the first image data are converted (or degraded) into the second image data of the second image quality standard that is inferior to the first image quality standard and the degraded second image data are printed and therefore the printed material that answers the intention of the author can be obtained.

Here, it is acceptable that the degradation step includes: a conversion step in which the reception device converts the first image data into the second image data and a transfer step in which the reception device transfers the converted second image data to the printing device, and in the print step, the printing device prints the second image data transferred from the reception device. Additionally, it is acceptable that the degradation step includes: a transfer step in which the reception device transfers the first image data to the printing device and a conversion step in which the printing device converts the transferred first image data into the second image data, and in the print step, the printing device prints the second image data converted in the conversion step.

Hereby, the first image data are degraded to the second image data of the second image quality standard that is inferior to the first image quality standard and the degraded second image data are printed and therefore the effect that the printed material that answers the intention of the author can be obtained is achieved.

Furthermore, it is desirable that in the transfer step, the reception device authenticates the printing device and transfers an encrypted first image data to the printing device after encrypting the first image data, and in the conversion step, the printing device decrypts the first imaged data transferred from the reception device and converts the decrypted first image data into the second image data.

Hereby, the first image data transferred from the reception device to the printing device is protected.

Moreover, it is possible that the authentication technique is DTCP (Digital Transmission Copy Protection).

Additionally, it is possible that the first image data are made up of plural print objects and in the degradation step, the conversion is executed for each print object. In this case, it is acceptable that in the print step, the printing device acquires and prints partial data repeatedly in a pull print mode according to a print instruction from the outside and in the pull print mode the partial data are the print objects.

Furthermore, it is acceptable that the conversion of the degradation step is changing resolution or an aspect ratio of an image indicated by the first image data.

Moreover, it is acceptable that the first image quality standard is the image quality standard of an HD image of digital broadcast, and the second image quality standard is the image quality standard that corresponds to an SD image of the digital broadcast. In this case it is possible that when the first image quality standard is the HD image quality standard of the digital broadcast, the second image quality standard is converted into the SD image quality standard of the digital broadcast.

Additionally, it is acceptable that the conversion of the degradation step is processing to combine the first image data with other image data.

Furthermore, it is acceptable that the conversion of the degradation step changes color information of the first image data.

Moreover, it is acceptable that the conversion of the degradation step limits a print size of the first image data to less than a predetermined size.

Additionally, it is acceptable that a mode of the conversion of the degradation step is determined by the type of the first image data.

Furthermore, it is acceptable that a different mode of conversion is executed in the degradation step depending on whether the type of the first image data is an HD image format of digital broadcast, a video format or a BML (Broadcast Markup Language) format.

Moreover, it is acceptable that in the degradation step, the conversion is executed only on a picture part included in the first image data when the format of the first image data is the BML (Broadcast Markup Language) format.

Additionally, it is possible that the printing method further includes: a print control information acquisition step in which the reception device acquires print control information that is information on print control distributed with the first image data and a degradation control step for determining whether or not the conversion in the degradation step is executed based on the acquired print control information.

Furthermore, it is acceptable that a flag that indicates one of “Print permitted”, “Print prohibited” and “Print permitted in the case of below the predetermined image quality standard” is included in the print control information, and in the degradation step, the conversion in the degradation step is executed when the flag indicates “Print permitted in the case of below the predetermined image quality standard”.

Moreover, it is acceptable that a flag indicating “degrade the image quality standard at the time of printing” is included in the print control information, and in the degradation control step, the conversion of the degradation step is executed when the flag indicates “degrade the image quality standard at the time of printing”.

Additionally, the broadcast data generation device according to the present invention is a broadcast data generation device that generates broadcast data including image data that can be printed comprising: a image data generating unit operable to generate image data; a print control information generation unit operable to generate print control information that is information to control printing of the generated image data; and a conversion unit operable to associate the generated image data with the print control information and to convert the image data and the print control information into the broadcast data.

Hereby, since the intention of the author is reflected by the print control information, the printed material that answers best the intention of the author can be obtained.

Here, it is acceptable that in the print control information, a flag that indicates one of “Print permitted”, “Print prohibited” and “Print permitted in the case of below the predetermined image quality standard” is included.

Furthermore, it is acceptable that in the print control information, a flag indicating “degrade the image quality standard at the time of printing” is included.

Consequently, by the present invention, a high-grade image is degraded to a low-grade image with reliability and the image is printed in the degraded state and therefore its practical value is extremely high because nowadays high-grade digital TV broadcast has started and highly efficient reception devices and printing devices are widely available.

By the way, the present invention can be realized not only as the printing method like this but also as a reception device and a printing device with the characteristic steps included in the printing method like this for the units. The present invention can be also realized as a program that causes a computer to execute these steps. Additionally, the present invention can be realized not only as the broadcast data generation device but also as a broadcast data generation method that have the characteristic units that the broadcast data generation device provides for the steps. The present invention can be also realized as a program that causes a computer to execute these steps. It goes without saying that these programs can be distributed through a recording medium such as CD-ROM and a transmitting medium such as Internet.

Here, in the present patent specification, to degrade a print image of the original image data means to convert to the state in which all the pixels of the original image data cannot be reproduced. For example, by skipping pixels of the original image data at a regular interval, by replacing a part of displayed pixels with other pixels or other images, by executing the predetermined conversions to the colors and by adding some kind of effects, to degrade a print image of the original image data means the processing by which a print image becomes different from a reproduced print image by an ordinary printing of the original image. In other words, to degrade a print image of the original image data means to convert the acquired first image data into the second image data of the second image quality standard that is inferior to the first image quality standard.

Japanese patent application No. 2002-041424 filed on Feb. 19, 2002 is incorporated herein by reference.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram that shows an overall structure of a printing system 1a according to the first embodiment.

FIG. 2 is a diagram that shows a structure example of print instruction information.

FIG. 3 is a block diagram that shows function structures of an STB, a monitor and a printer shown in FIG. 1.

FIG. 4 is a structure example of a degradation processing instruction table.

FIG. 5 is a flowchart that shows operations each part of the STB shown in FIG. 3 executes.

FIG. 7 is diagrams that show manner of degradation processing of an image and particularly

FIG. 7A is a diagram that shows an original image before the degradation processing;

FIG. 7B is a diagram that shows an image to which degradation processing is done by pixel skipping;

FIG. 7C is a diagram that shows an image to which degradation processing is done by converting a color image to a monochrome image; and

FIG. 7D is a diagram that shows an image to which degradation processing is done by throwing the surroundings out of focus (by edging).

FIG. 8 is a diagram that shows a function structure of a printing system according to the second embodiment.

FIG. 9 is a flowchart that shows operations each part of the STB shown in FIG. 8 executes.

FIG. 10 is a flowchart that shows processing that each part of the printer shown in FIG. 8 executes.

FIG. 11 is a structure example of a degradation processing instruction table.

FIG. 12 is diagrams that show manner of degradation processing of an image,

FIG. 12A is a diagram that shows an original image before the degradation processing and

FIG. 12B is a diagram that shows an image to which degradation processing is done by pixel skipping.

FIG. 13 is a diagram that shows a function structure of a printing system according to the third embodiment.

FIG. 14 is a flowchart that shows operations of processing that each part of a printer shown in FIG. 13 executes.

FIG. 15 is diagrams that show component parts of print data written in BML format,

FIG. 15A and FIG. 15B are diagrams that show text data and

FIG. 15C is a diagram that shows image data linked to the text data.

FIG. 16 is diagrams that show manner of degradation processing of an image,

FIG. 16A is a diagram that shows an original image before the degradation processing and

FIG. 16B is a diagram that shows an image to which degradation processing is done by pixel skipping.

FIG. 17 is a diagram that shows a function structure of a printing system according to the fourth embodiment.

FIG. 18 is a diagram that shows a structure example of print instruction information.

FIG. 19 is a flowchart that shows operations that each part of the STB shown in FIG. 17 executes.

### DESCRIPTION OF THE PREFERRED EMBODIMENT(S)

(The first embodiment)

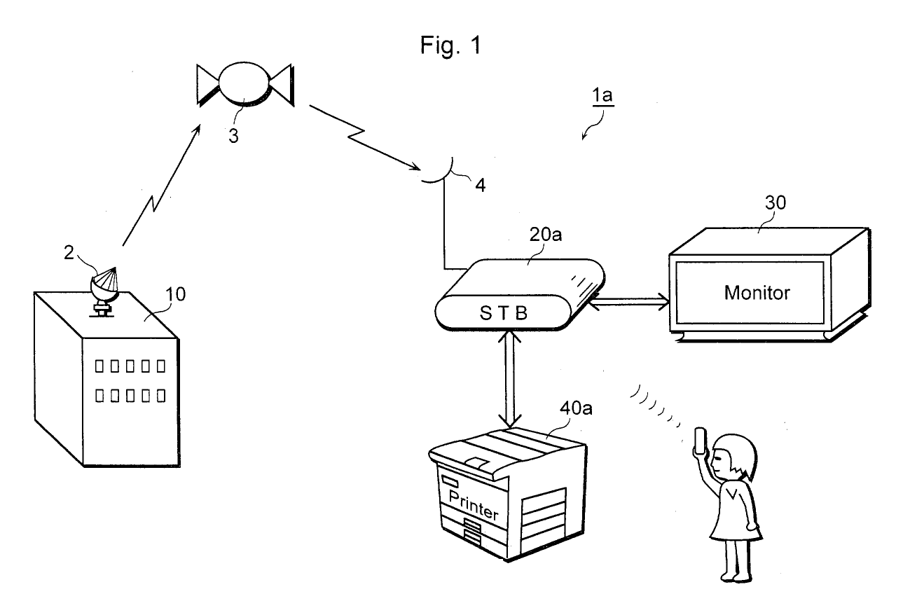

FIG. 1 is a diagram that shows an overall structure of a printing system 1a according to the first embodiment.

This printing system 1a is made up of a broadcast station 10 that transmits broadcast data through an antenna 2 and a satellite 3, a Set Top Box (hereafter, also written as “STB”) 20a that receives the broadcast data through an antenna 4, a monitor 30 and a printer 40a that are connected to this STB.

The broadcast station 10 is a broadcast data generation device that generates broadcast data including image data that can be printed and comprises a image data generation unit (not shown in the figure) that generates image data, a print control information generation unit (not shown in the figure) that generates print control information (also written as “print instruction information”) that is information to control printing of the generated image data and a conversion unit (not shown in the figure) that associates the generated image data with the print control information and converts the image data and the print control information into the broadcast data.

The broadcast data transmitted by the broadcast station 10 are transmitted by HTML (Hyper Text Markup Language) format, MPEG (Moving Picture Experts Group) format and BML (Broadcast Markup Language) format. Additionally, print instruction information that is an instruction from a manager of a copyright (an author copyright holder, a manager of broadcast station) on printing is included and encoded in this broadcast data and “Print permitted”, “Print prohibited” or “Print in the case of low resolution permitted” can be specified.

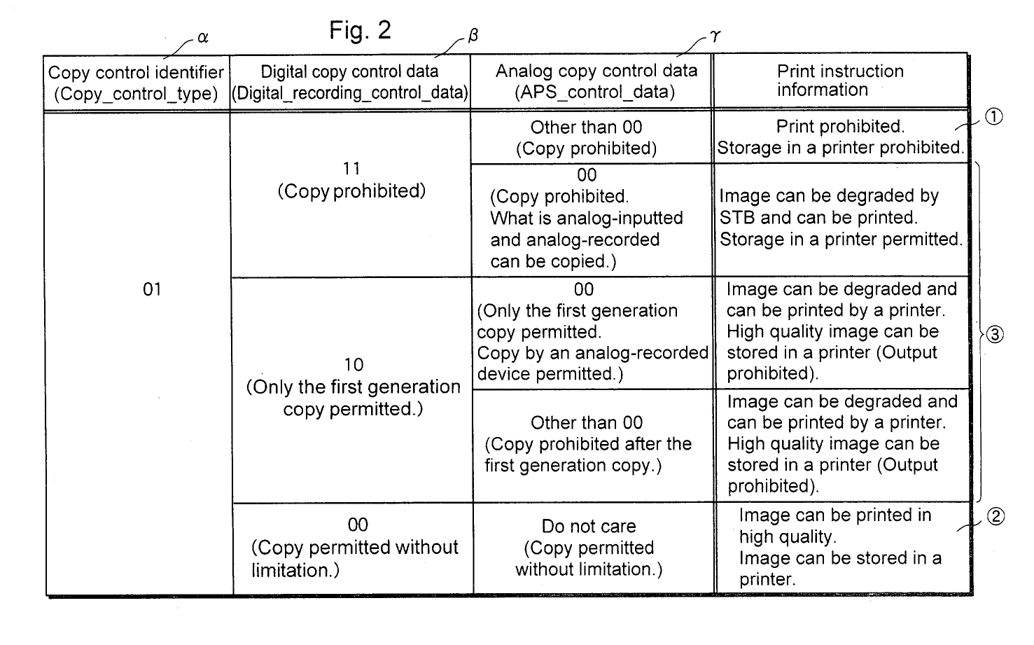

To be more specific, this print instruction information is, for example, what copy control information to control copy of the contents stipulated by the broadcast standard ARIB STD-B10 and the like used for BS digital broadcast is converted and used. The print instruction information is, as is shown in FIG. 2, made up of a copy control identifier α that represents to be copy control information, digital copy control data β to control a digital copy and analog copy control data γ to control an analog copy.

For example, when the value of the digital copy control data β is “0×11”, a digital copy is prohibited and when the value of the analog copy control data γ is other than “0×00”, an analog copy is also prohibited. In the case of using them as the print instruction information, they can be the print instruction information that represents an instruction that prohibits both of printing and data storage in the printer. Furthermore, when the value of the digital copy control data β “0×00”, there is no limit to digital copy, while the value of the analog copy control data γ represents “Do not care”, there is no limit to copy. In this case, the digital copy control data β and the analog copy control data γ can be the print instruction information that represents the instruction that the image that is a print object can be printed in high quality by the printer and the high quality image can be stored in the printer.

On the other hand, when the value of the digital copy control data β is “0×11”, a digital copy is prohibited but when the value of the analog copy control data γ is “0×00”, what is analog-inputted and analog-recorded can be copied. In this case, the digital copy control data β and the analog copy control data γ can be the print instruction information that represents the instruction that the image that is a print object can be degraded and printed by the STB and the degraded image can be stored in the printer. Furthermore, when the value of the digital copy control data β is “0×10”, only the first generation digital copy can be copied and when the value of the analog copy control data γ is “0×00” or other than “0×00”, the specified copy is possible. In this case, the digital copy control data β and the analog copy control data γ can be the print instruction information that represents the instruction that the image that is a print object can be degraded and printed by the printer and high quality image can be stored in the printer.

In other words, by combining the digital copy control data β and the analog copy control data γ, besides the first flag \mathring{1} to prohibit all the printing, the second flag \mathring{2} to permit printing without any limitations, the third flag \mathring{3} that permits printing after the degradation is structured and this flag \mathring{3} can instruct a low quality printing.

STB 20a receives the broadcast data, extracts the image data and the like from the broadcast data received through the antenna 4, transmits the extracted image data and the like to the monitor 30 and has the monitor 30 display the extracted image data. Receiving a print instruction that the user wants to print the image displayed on the monitor 30 from the user, the STB 20a stops transmitting the image data that the user has instructed to be printed based on the print instruction information to the printer 40a (when the print instruction information represents the first flag \mathring{1}, namely, in the case of prohibiting the printing), or encrypts the image data that the user has instructed to be printed and transmits the data to the printer 40a (when the print instruction information represents the second flag \mathring{2} namely, in the case of permitting the printing and the third flag \mathring{3}, namely, in the case of permitting the printing after degradation). In addition, when the print instruction information represents that printing is permitted after degradation, the STB 20a is structured to transmit c ontrol information that instructs degradation to the printer 40a.

The monitor 30 displays the image of the broadcast data that the STB 20a has received.

The printer 40a decrypts the encrypted image data, degrades the image to be printed based on the instruction of the STB 20a and prints the image on a paper.

Moreover, the STB 20a, the monitor 30 and the printer 40a are connected each other through IEEE1394 bus, USB and the like and an I/F (Interface) unit of the each device interfaces the data in the mode that is compatible with the connected bus.

Next, the structure of the STB 20a, the monitor 30 and the printer 40a is explained in detail.

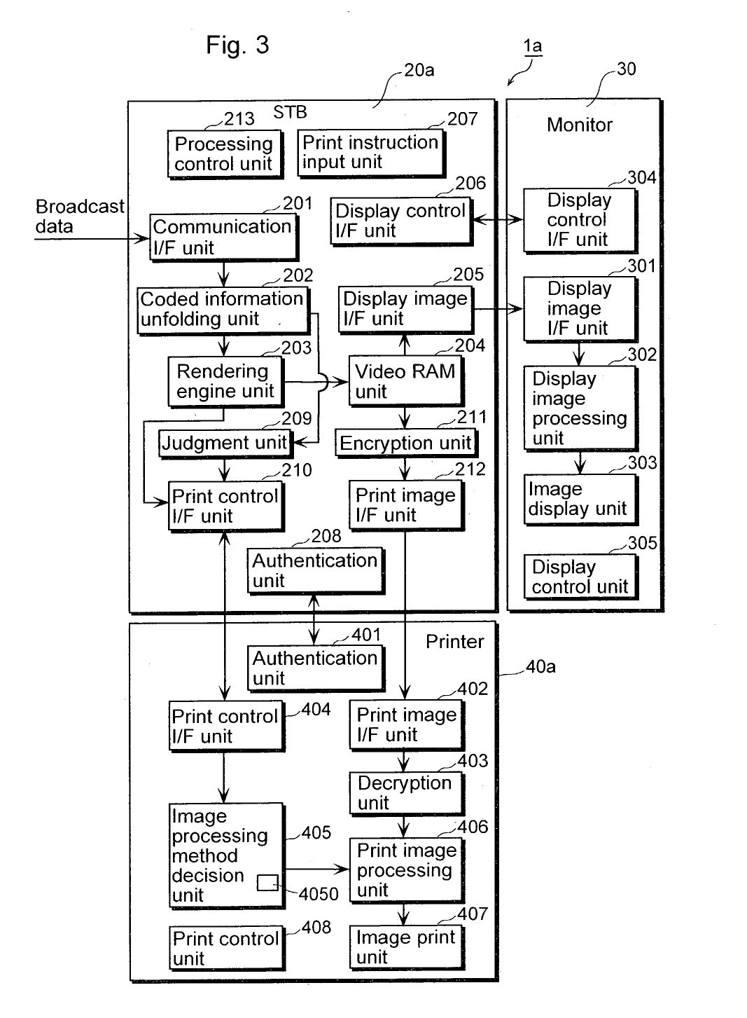

FIG. 3 is a block diagram that shows function structures of the STB 20a, the monitor 30 and the printer 40a shown in FIG. 1.

As shown in FIG. 3, the STB 20a is made up of a communication I/F unit 201, a coded information unfolding unit 202, a rendering engine unit 203, a video RAM unit 204, a display image I/F unit 205, a display control I/F unit 206, a print instruction input unit 207, an authentication unit 208, a judgment unit 209, a print control I/F unit 210, an encryption unit 211, a print image I/F unit 212 and a processing control unit 213. In addition, each unit that makes up the STB 20a like this is realized by a CPU, a ROM that stores programs and data that are executed by the CPU in advance, memory that provides a work area at the time of executing the programs and stores the broadcast data and the like temporarily.

The broadcast data received through the antenna 4 is inputted into the communication I/F unit 201.

The communication I/F unit 201 executes predetermined processing to the inputted broadcast data and outputs the data to the coded information unfolding unit 202.

The coded information unfolding unit 202 executes detection and processing of the print instruction information included in encoded information that is compatible with the mode of the inputted broadcast data, extracts the image data, transmits the detected print instruction information to the judgment unit 209 and transmits the extracted image data to the rendering engine 203.

The rendering engine unit 203 renders the image data provided by the coded information unfolding unit 202 on the video RAM unit 204. Additionally, when the printing is permitted in the case of the degradation, the rendering engine unit 203 outputs control data to execute image processing that is necessary for ordinary printing (image processing for printing) to the printer 40a. Moreover, this image processing for printing is processing that converts (usually enlarges) the original image data to the resolution of a printing device (a printer) and corrects image degradation accompanying the enlargement with various methods.

The video RAM unit 204 outputs the rendered image data to the display image I/F unit 205 when there is no print instruction from the user and outputs the rendered image data to the encryption unit 211 when there is a print instruction from the user.

The display image I/F unit 205 transmits the image data to the monitor 30.

The display control I/F unit 206 transmits and receives the control data to and from the monitor 30.

The print instruction input unit 207 receives the input of the print instruction from the user. In addition, the print instruction input unit 207 may have any forms such as buttons or a remote control device equipped with the STB 20 and the printer 40 or a personal computer (not in the figure) in the system.

The authentication unit 208 of the STB 20a is paired with an authentication unit 401 of the printer 40 that will be described later. To be more specific, the authentication unit 208 authenticates following procedures of an authentication technique called DTCP (Digital Transmission Copy Protection) and excludes unauthorized devices.

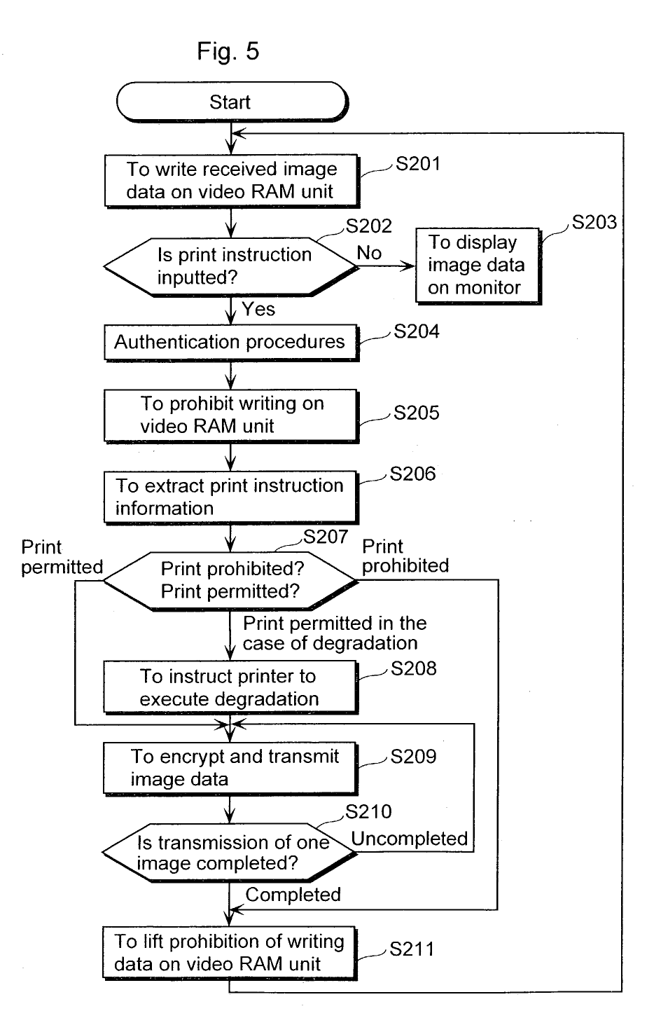

The judgment unit 209 interprets the print instruction information transmitted from the coded information unfolding unit 202. In other words, the judgment unit 209 judges which one of the following is transmitted: the first flag \mathring{1} (Print prohibited), the second flag \mathring{2} (Print permitted) or the third flag \mathring{3} (Print permitted in the case of degradation). When the information is “Print permitted in the case of degradation”, the judgment unit 209 generates certain control data to instruct the degradation at Step S208 shown in FIG. 5 and transmits the control data to the printer 40a through the print control I/F unit 210. This control data to instruct the degradation is, for example, is made up of a one-bit flag that represents a degradation instruction. Furthermore, when the print instruction information is “Print permitted”, the judgment unit 209 does not particularly specify the image processing method.

The print control I/F unit 210 transmits or receives the control data to and from the printer 40a. For example, the print control I/F unit 210 transmits the control data outputted from the rendering engine unit 203 and the control data outputted from the judgment unit 209 to the printer 40a.

Encryption unit 211 executes the predetermined encryption processing to the image data rendered on the video RAM unit 204. In the case of the cipher system based on DTCP, the encryption is executed in units of the predetermined byte number. The encrypted image data are transmitted to the print image I/F unit 212.

The print image I/F unit 212 transmits the encrypted image data to the printer 40a.

The processing control unit 213 controls each unit 201˜212 in the STB 20a across the board. When the print instruction information is “Print prohibited”, the processing control unit 213 ignores the input of the print instruction inputted by the print instruction input unit 207.

The monitor 30 is made up of a display image I/F unit 301, a display image processing unit 302, a image display unit 303, a display control I/F unit 304 and a display control unit 305.

The display image I/F unit 301 supplies the image data received from the display image I/F unit 205 of the STB 20a to the display image processing unit 302.

The display image processing unit 302 executes the predetermined process to the inputted image data and supplies the image data to the image display unit 303.

The image display unit 303 is a display device such as a CRT (Cathode Ray Tube), an LCD (Liquid Crystal Display), a PDP (Plasma Display Panel) and a projector and displays an image based on the image data processed by the display image processing unit 302 with the quality of the original image.

The display control I/F unit 304 receives the control data from the display control I/F unit 206 of the STB 20a and outputs the received control data to the display control unit 305.

The display control unit 305 controls each unit 301˜304 across the board based on the control data outputted by the display control I/F unit 304.

The printer 40a is made up of an authentication unit 401, a print image I/F unit 402, a decryption unit 403, a print control I/F unit 404, an image processing method decision unit 405, a print image processing unit 406, an image print unit 407 and a print control unit 408. In addition, each unit that makes up the printer 40a like this is realized by a CPU, a ROM that stores programs and data that are executed by the CPU in advance, memory that provides a work area at the time of executing the programs and stores the image data and the like temporarily.

The authentication unit 401 and the authentication unit 208 of the STB 20a authenticate each other.

The print image I/F unit 402 receives the image data transmitted by the print image I/F unit 212 of the STB 20a and transmits the received image data to the decryption unit 403.

The decryption unit 403 decrypts encrypted image data and supplies the decrypted image data to the print image processing unit 406.

The print control I/F unit 404 receives the control data transmitted by the print control I/F unit 210 of the STB 20a and supplies the received control data to the image processing method decision unit 405.

The image processing method decision unit 405 decides processing contents based on the contents of the control data and instructs the print image processing unit 406 to execute the processing contents.

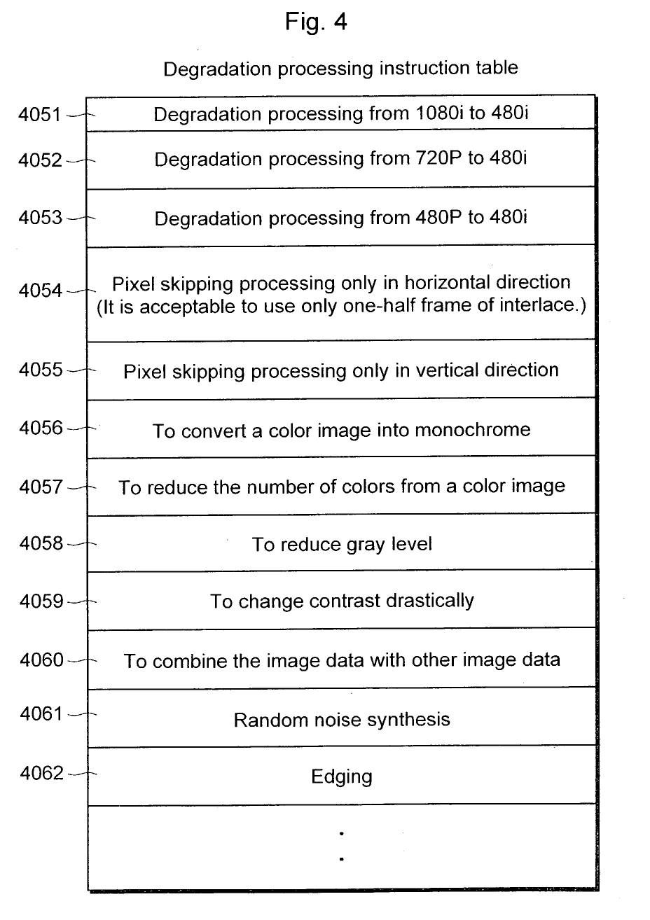

Moreover, receiving the control data to instruct the degradation, the image processing method decision unit 405 memorizes in advance a degradation processing instruction table 4050 shown in FIG. 4 that stores the plural processing contents to instruct the print image processing unit.

This degradation processing instruction table 4050 is created from either one of a degradation method or a degree of the degradation or the combination of the two. “The degree of the degradation” is, for example, the degradation of the resolution to the SD (Standard Definition) image quality level, fifty percent pixel skipping, the area or the proportion of area in which the original image quality level remains and the like. Additionally, “the degradation methods” are aspect ratio conversion, pixel reduction by pixel skipping or the like, reduction in color reproducibility, application of image edition effect like blurring, etc.

Here, the predetermined image processing includes one or both of the degradation and the above-mentioned image processing for printing.

FIG. 4 is a diagram that shows a structure example of a degradation processing instruction table 4050 created based on the degradation method and the degree of the degradation.

Here, the resolution of image data on the screen that the STB 20a displays is decided by the standard of 1080i, 720P, 480P, 480i and the like.

Degradation processing from 1080i to 480i skips the horizontal pixels by fifty percent and the vertical pixels by fifty percent. Since the number of the pixels becomes half and the size of image data shrinks, the image data are interpolated by the pixels adjacent to the skipped pixels.

Additionally, degradation processing from 720P to 480i skips the horizontal pixels to two thirds and the vertical pixels to two thirds and the image data are interpolated by the pixels adjacent to the skipped pixels. Furthermore, degradation from 480P to 480i skips the horizontal pixels to half and the vertical pixels to two thirds and the image data are interpolated by the pixels adjacent to the skipped pixels. In addition, the pixel skipping processing can be the horizontal skipping only or the vertical skipping only. Moreover, it is thinkable to use only one-half frame of interlace for the pixel skipping processing.

After the degradation processing is done, the image processing for printing like enlargement/shrinking processing is executed.

There are other degradation methods: to convert a color image into monochrome by converting the color information of the image data from R (red), G (green) and B (blue) to K (black); to reduce the number of colors by restricting the colors of ink to be used; to reduce gray level; to change contrast drastically; and to combine the image data with other image data or a random noise.

Additionally, if the size of a printed image is sufficiently small, the object to degrade the image is achieved. Consequently, there is also a degradation method to restrict the size of the print image sufficiently small. For example, the print image is restricted to 3 cm long and 4 cm wide or 36 mm long and 64 mm wide or smaller.

The print image processing unit 406 executes the predetermined processing instructed by the image processing method decision unit 405 to the inputted image data and converts the image data to the data that the image print unit 407 can print.

The image print unit 407 prints the image based on the image data from the print image processing unit 406 with the predetermined resolution (200/300/400 dpi, for example). The print methods are thermal, thermal transfer, dye sublimation, inkjet and the like.

The print control unit 408 controls each unit 401˜407 across the board based on the control data that the print control I/F unit 404 and responses from each unit.

Next, the operations of each unit of the STB 20a are explained.

FIG. 5 is a flowchart that shows operations each part of the STB executes.

When there is no print instruction from the user, the coded information unfolding unit 202 outputs the image data extracted from the broadcast data to the rendering engine unit 203 in sequence. The rendering engine unit 203 writes and renders the image data outputted by the coded information unfolding unit 202 on the video RAM unit 204 (S201). The image data written on the video RAM unit 204 are transmitted to the display image I/F unit 301 through the display image I/F unit 205 and are displayed on the image display unit 303. While the rendering engine unit 203 is rendering, the processing control unit 213 monitors input from the print instruction input unit 207. Then the processing control unit 213 judges whether or not there is an input from the print instruction input unit 207. In other words, the processing control unit 213 judges whether or not the input is a print instruction (S202). Judging that the input is not a print instruction, the processing control unit 213 supplies the image data rendered on the video RAM unit 204 to the monitor 30 through the display image I/F unit 205. As a result, each unit of the monitor 30 displays the inputted image data by executing the predetermined processing based on the inputted image data (S203). As a result, as long as a print instruction is not inputted (No at S202), the image data inputted into the STB 20a continues to be displayed on the monitor 30 in sequence by the repetition of processing of Steps S201˜S203.

On the other hand, when the processing control unit 213 judges that a print instruction is inputted (Yes at S202), the authentication unit 208 of the STB 20a executes the authentication procedures with the authentication unit 401 of the printer 40a following the procedures of DTCP (S204). If the print instruction is disapproved by the authentication procedures, the processing control unit 213 refuses the input from the print instruction input unit 207 or even if the processing control unit 213 accepts the input, the processing control unit 213 does not execute print related processing from S205 onwards that will be described later. In addition, the authentication procedures may be executed at the time when the STB 20a and the printer 40a are connected or before the printing is instructed. In the case, it is acceptable that success and failure of the authentication are recorded and when the processing control unit 213 judges that a print instruction is inputted at Step S202 the print related processing from S205 onwards is executed if the authentication procedures have succeeded.

When the authentication procedures succeed, the processing control unit 213 controls the rendering engine to not execute a new rendering. In other words, the processing control unit 213 controls each device to not update the image data rendered on the video RAM unit 204. Namely, the processing control unit 213 prohibits writing on the video RAM unit 204 (S205). Here, the reason that the processing control unit 213 stops writing the image data on the video RAM unit 204 when a print instruction is inputted and the authentication procedures succeed is to prevent the inconvenience that the image data in the video RAM 204 are updated during the transmission to the printer and the print image becomes a different image part-way.

On the other hand, when a print instruction is inputted and the authentication procedures succeed, the coded information unfolding unit 202 extracts the print instruction information from the control data that corresponds to the image data to which printing is instructed and transmits the print instruction information to the judgment unit 209 (S206).

When the print instruction information is transmitted, the judgment unit 209 interprets the print instruction information (S207). In other words, the judgment unit 209 interprets the contents of the print instruction information based on the digital copy control data β and the analog copy control data γ to control an analog copy to judge which one of the following is transmitted: “Print prohibited”, “Print permitted” or the third way, “Print permitted in the case of degradation”. When the contents are “Print permitted in the case of degradation”, the judgment unit 209 generates the control data of a certain degradation instruction and transmits the data to the printer 40a through the print control I/F unit 210 (S208). Namely, the judgment unit 209 instructs the printer 40a to execute the degradation by the generated control data (S209).

When the judgment unit 209 instructs the printer 40a to execute the degradation, after processing to encrypt the predetermined amount of image data of the video RAM unit 204, encryption unit 211 provides the encrypted image data to the printer 40a through the print image I/F unit 212.

Then, processing control unit 213 judges whether or not one image of the image data are provided to the printer 40a (S210) and has the encryption unit repeat the process of S209 until one image of the print data is provided. Judging that one image of the image data is provided (Completion at S210), the processing control unit 213 lifts the prohibition of updating the rendering data on the video RAM unit 204 at Step S204 (the prohibition of writing on the video RAM unit 204) (S211). Then, the process of Steps S201˜S203 is repeated and the next image is displayed on the monitor in sequence.

Additionally, when the contents of the print instruction information received by the judgment unit 209 at Step S207 is “Print permitted” (Permitted at S207), the processing control unit 213 skips Step 208, in other words, does not instruct the printer 40a to degrade because there is no need for degrading the image quality and starts to transmit processing of the image data shown at Step 209 to the printer 40a (S209, S210). On the other hand, in the case of “Print prohibited” (Prohibition at S207), the prohibition of updating the rendering data in the video RAM unit 204 shown at Step S211 is lifted and the processing returns to S201.

Moreover, when an image data buffer unit to extract the image data being instructed to be printed from the video RAM unit 204 and to execute buffering is set up in the STB 20a, the timing to lift the prohibition of rendering on the video RAM unit 204 at Step S210 becomes when the transfer of the image data to the image data buffer unit has completed.

Next, the processing that is executed in the printer 40a is explained.

FIG. 6 is a flowchart that shows processing each part of the printer 40a executes.

The print control I/F unit 404 receives the control data transmitted by the STB 20a and transmits the received control data to the image processing method decision unit 405 (S301). In addition, this control data includes not only the ordinary data to control the printer 40a but also the control data to instruct the degradation corresponding to the image data of the print object.

The image processing method decision unit 405 judges whether or not the control data to instruct the degradation are included in the control data (S302). Judging that the control data to instruct the degradation is included (Yes at S302), the image processing method decision unit 405 selects one degradation processing, referring to the degradation processing instruction table 4050, and instructs the print image processing unit 406 to execute the predetermined image processing to the image data (S303). When the print instruction information is “Print permitted”, the control data to instruct the degradation are not transmitted by the STB20a (No at S302), the image processing method decision unit 405 does not particularly specify the image processing method to the print image processing unit 406.

In addition, in the case of writing which degradation method is adopted in the contents in the print instruction information, the judgment unit 209 of the STB 20a transmits the degradation method as well as the control data to the printer 40a and the image processing method decision unit 405 specifies the degradation method to the print image processing unit 406, which degrades the image quality with the most appropriate degradation method to the contents image.

On the other hand, the decryption unit 403 decrypts the encrypted image data received through the print image I/F unit 402 and transmits the decrypted image data to the print image processing unit 406 (S304). The print image processing unit 406 processes the image data with the image processing method specified by the image processing method decision unit 405 (S305). In other words, in the case of judging that the control data to instruct the degradation are included (Yes at S302), the image processing method decision unit 405 instructs the print image processing unit 406 to degrade the image (S303) and the print image processing unit 406 executes the processing to degrade the decrypted image data (S305).

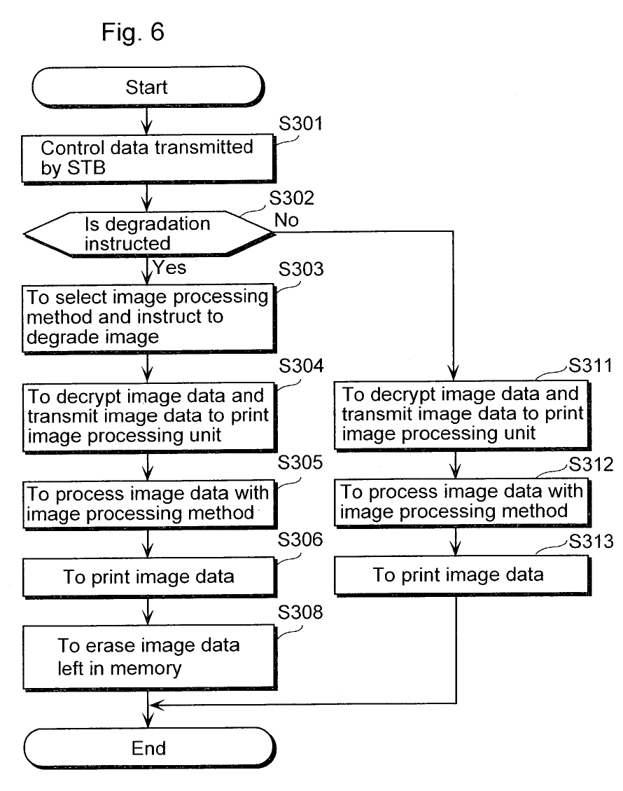

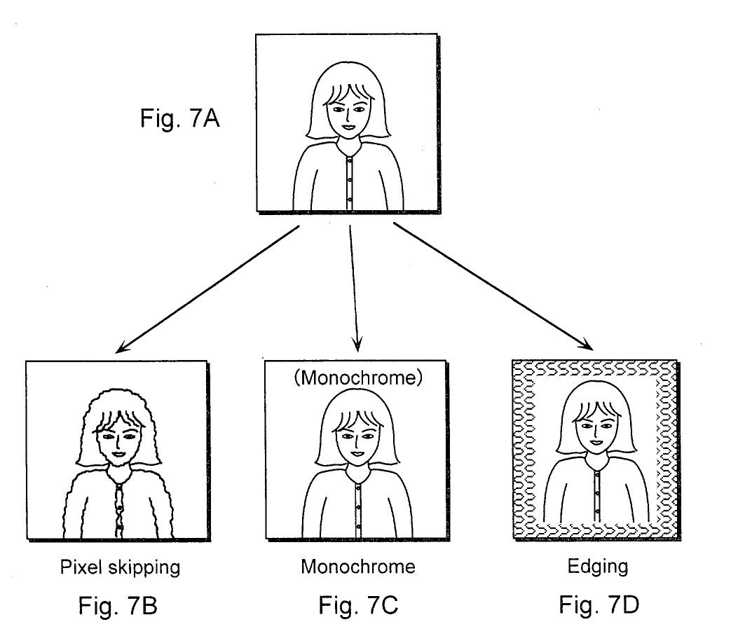

FIG. 7 is diagrams that show manner of degradation processing of an image and particularly

FIG. 7A shows an original image before the degradation processing;

FIG. 7B shows an image to which degradation processing is done by pixel skipping;

FIG. 7C shows an image to which degradation processing is done by converting a color image to a monochrome image; and

FIG. 7D shows an image to which degradation processing is done by throwing the surroundings out of focus (by edging), respectively.

When the image data to which the image degradation processing like this is executed are transmitted, the image print unit 407 prints the image on a paper based on the image data processed to be degenerated (S306).

Finishing printing on the paper, the print control unit 408 erases the image data left in the memory of the printer (S308). In other words, the print control unit 408 erases the decrypted image data before degradation processing.

On the contrary, judging that the control data to instruct the degradation are not included (No at S302), in other words in the case of the second flag \mathring{2}, the image processing method decision unit 405 does not instruct the print image processing unit 406 to execute the predetermined image processing to the image data. In this case also, the decryption unit 403 decrypts the encrypted image data received through the print image I/F unit 402 and transmits the decrypted image data to the print image processing unit 406 (S311). The print image processing unit 406 processes the image data with the image processing method specified by the image processing method decision unit 405 (S312). In addition, when the print instruction information is “Print permitted”, the image processing method decision unit 405 does not particularly specify the image processing method to the print image processing unit 406 but at that time the image processing method that the print image processing unit 406 should apply in the case of no instruction is predetermined, and the print image processing unit 406 processes the image data with the method. The image print unit 407 prints the image on the paper based on the processed image data (S313).

As explained above, according to the first embodiment of the present invention, when the print instruction information indicates print permitted in the case of degradation, the STB 20a that receives the image data distributed from outside acquires the first image data of the first image quality standard and transmits the acquired image data with the control information to instruct the degradation to the printer 40a, which converts the first image data to the second image data of the second image quality standard that is inferior to the first image quality standard and prints the converted second image data, and therefore the printed material that answers the intention of the author can be acquired.

In addition, in the first embodiment, the part that processes to degrade the image data is loaded in the printer 40a but there is no need to restrict particularly to the printer 40a. It is acceptable to load the part in the STB 20a, the main body such as a TV that incorporates a tuner that receives the broadcast data and another server that distributes the image data.

Furthermore, in the first embodiment, the control data to instruct the degradation is explained as a one-bit flag but it is acceptable to add an area to store control contents to this flag and to include “the degree of the degradation” and “the method of the degradation” in this area. In this case, it is possible for the printer 40a to execute the degradation processing that is appropriate to the image.

(The second embodiment)

Next, a printing system according to the second embodiment of the present invention is explained.

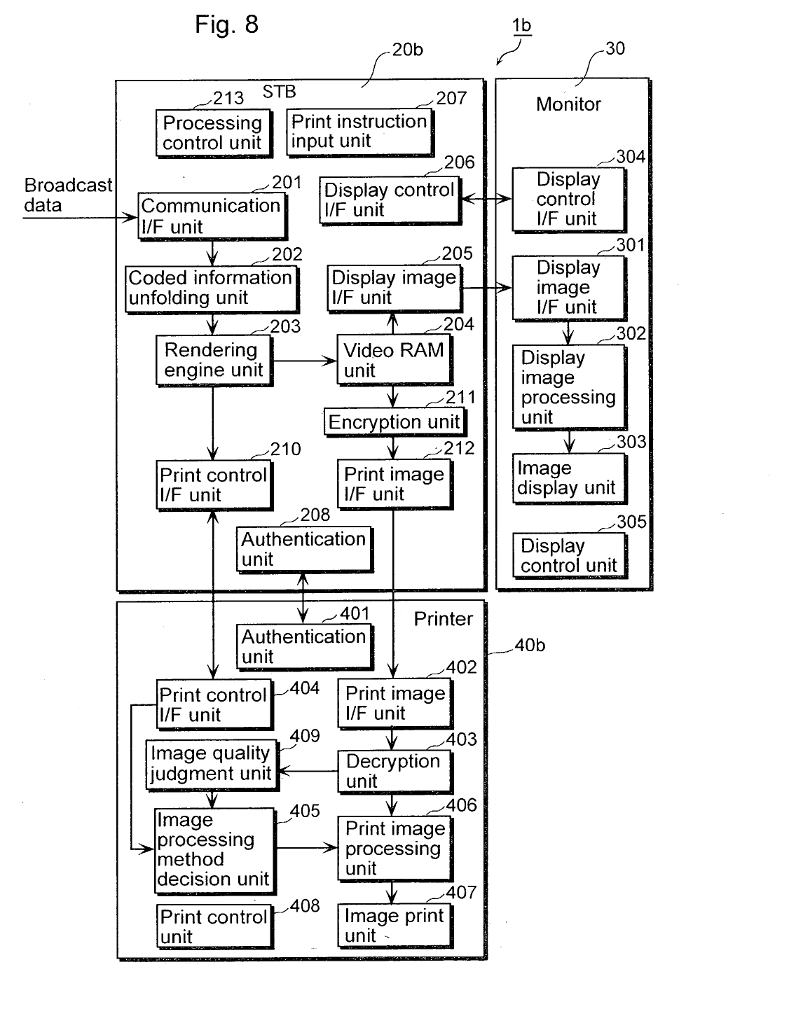

FIG. 8 is a diagram that shows a function structure of a printing system 1b according to the second embodiment.

This printing system according to the second embodiment is made up of a broadcast station 10, an STB 20b, a monitor 30 and a printer 40b. In the FIG. 8, graphic representation of the broadcast station 10 is omitted. Additionally, the same component parts of the STB 20a, the monitor 30 and the printer 40a shown in FIG. 3 are given the same numbers and their explanations are omitted.

Here, the printing system 1a according to the first embodiment is structured to decide whether or not the image degradation processing is executed according to the contents of the print instruction information but the printing system 1b according to the second embodiment is structured to decide whether or not the image degradation processing is executed based on a rule that the degradation processing is executed if the quality of the image data is higher than the predetermined level.

According to this structure, the print instruction information included in the broadcast data and added to the image data and the judgment unit 209 of the STB 20a are unnecessary. For this reason, the STB 20a of the printing system 1b is structured omitting the judgment unit 209 and on the other hand the printer 40b is structured to be equipped with a image quality judgment unit 409 that reads image quality information from added data in the image data, resolution of the image data or the like.

When the image data are transmitted from the STB 20a, this image quality judgment unit 409 reads the image quality information of the image data from the added data in the image data decrypted by the decryption unit 403, the resolution of the image data or the like and transmits the read image quality information to the image processing method decision unit 405. For example, whether or not the image data are of HD (High Definition) quality can be read from the header information added to the image data and can be judged from matrix-like resolution of the image data.

Next, operations executed by each unit of the STB 20b and each unit of the printer 40b are explained in sequence.

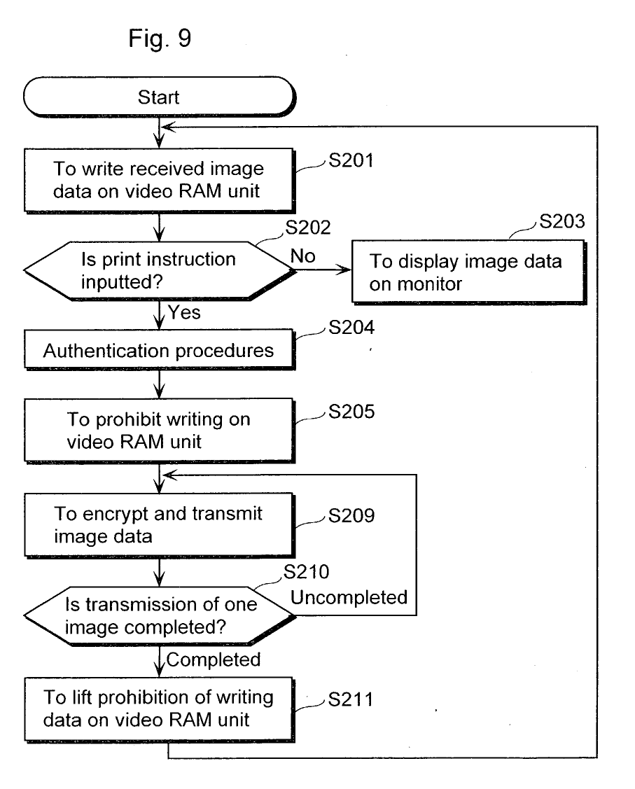

FIG. 9 is a flowchart that shows the operations each part of the STB 20b executes. In addition, up to Step S205 the operations are same as those in FIG. 5 of the first embodiment, the explanation is omitted.

When the processing to prohibit writing on the video RAM unit 204 is executed (S205), the encryption unit 211 encrypts the image data and transmits the encrypted image data to the printer 40b (S209). In other words, in the STB 20b according to the second embodiment, Steps S206˜S208 that are the processing executed in the first embodiment, namely, the processing to extract the print instruction information, the judgment of the print instruction information and the degradation instruction to the printer when the judgment is the degradation instruction are omitted.

Consequently, the structure of the STB 20b is simpler than that of the STB 20a and the load of STB 20b is reduced.

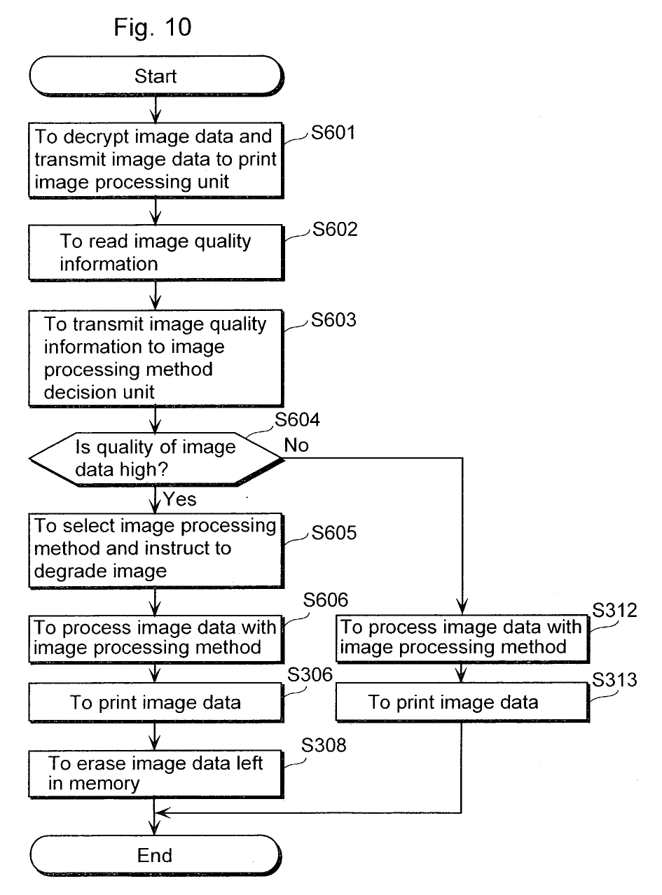

FIG. 10 is a flowchart that shows processing that each part of the printer 40b shown in FIG. 8 executes.

Receiving the encrypted image data transmitted by the STB20b through the print image I/F unit 402, the decryption unit 403 decrypts the encrypted image data and transmits the decrypted image data to the image quality judgment unit 409 as well as the print image processing unit 406 (S601).

The image quality judgment unit 409 that has received the image data reads the image data main body of the decrypted image data and the image quality information such as the added data in the image data and the resolution of the image data (S602). This image quality information is detected by, for example, reading whether or not the image data are of HD (High Definition) quality from the header information added to the image data and reading the matrix-like resolution of the image data.

Finishing the detection the image quality judgment unit 409 transmits the detected image quality information to the image processing method decision unit 405 (S603). The image processing method decision unit 405 judges from the transmitted image quality information whether or not the quality of the image data is higher than the predetermined level (S604). If the quality of the image data is higher than the predetermined level (Yes at S604), the image processing method decision unit 405 specifies the image processing method to degrade the image to the print image processing unit 406 (S605). For example, when the image data are of HD image quality, the image processing method decision unit 405 instructs the print image processing unit 406 to execute the image processing to degrade the HD image quality to the SD (Standard Definition) image quality. This instruction may be executed based on a degradation processing instruction table 4070 shown in FIG. 11. According to this degradation processing instruction table 4070, when the image quality information is of the HD image quality, the image quality is the high quality and the image processing method to degrade to the SD image quality by the pixel skipping and the like is instructed. In addition, when the image quality information is of SD image quality, the image quality is the low quality image and the image processing method to degrade the image quality is not written.

Receiving an instruction as to the image processing method, the print image processing unit 406 processes the image data with the image processing method specified by the image processing method decision unit 405 (S606).

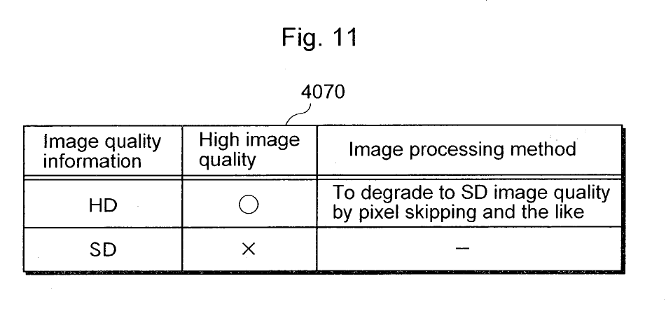

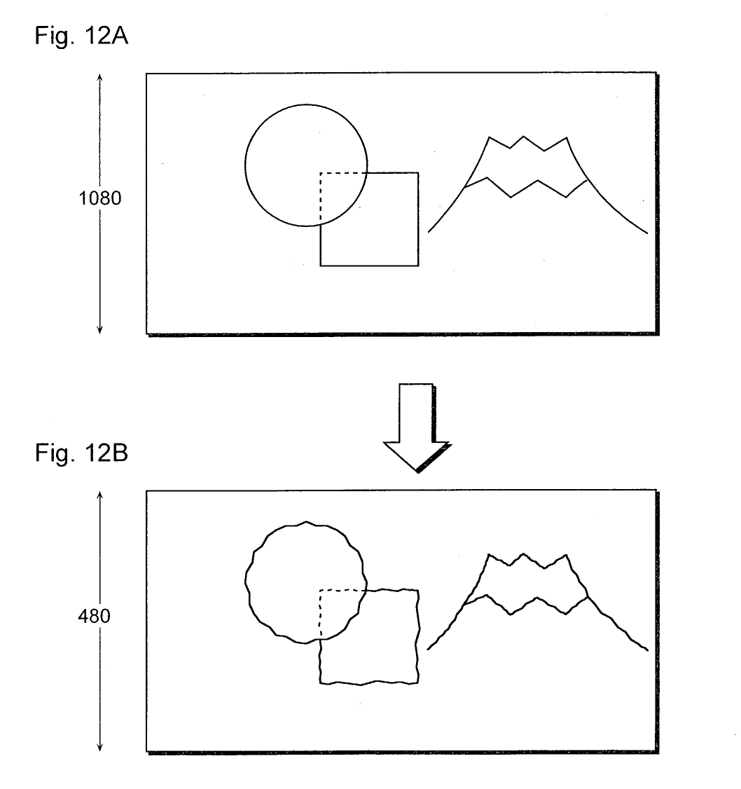

FIG. 12 is diagrams that show manner of degradation processing of an image and particularly FIG. 12A is a diagram that shows an original image before the degradation processing and FIG. 12B is a diagram that shows an image after the degradation processing to the SD image quality. In the print image of the HD image quality, aliasing is not visible and therefore it is apparent that the print image of the HD image quality is of high image quality while in the print image of the SD image quality, aliasing is clearly visible and therefore it is apparent that the image quality is degraded.

With no instruction as to the image processing method, the print image processing unit 406 executes an ordinary print processing similarly to the case of the first embodiment. In this case, the original image is of low image quality, is printed in the low image quality as is and therefore there is no need to degrade the image quality. Additionally, since the processing afterwards (S307, S308) is similar to that of the first embodiment, the explanation is omitted.

As is apparent from the explanation above, the printed material that answers the intention of the author can be also acquired according to the second embodiment of the present invention.

In addition, the printing system 1b according to the second embodiment is structured in order that the decryption unit 403b transmits the decrypted image data also to the image quality judgment unit 409 but it is acceptable that the printing system 1b according to the second embodiment is structured in order that the image quality judgment unit 409 monitors the decrypted image data and acquires the image quality information based on the monitor result.

Additionally, the image quality judgment unit 409 is set up in the printer 40b according to the second embodiment but it is acceptable that the printing system 1b is structured in order that the image quality judgment unit 409 is set up in the STB 20b. In this case, it is acceptable that the image quality judgment unit 409 detects the quality of the image data by receiving the image data from the video RAM unit 204 or by monitoring the image data in the video RAM unit 204 to transmit the image data to the printer 40b and transmits the detection result to the print image processing unit 406 through the print control I/F units 210 and 404.

Furthermore, it is also acceptable to set up the judgment unit 209 in the STB 20b and to transmit the image data from the STB 20b to the printer 40b only when the judgment unit 209 judges that the print instruction information is not “Print prohibited”.

(The third embodiment)

Next, a printing system according to the third embodiment of the present invention is explained.

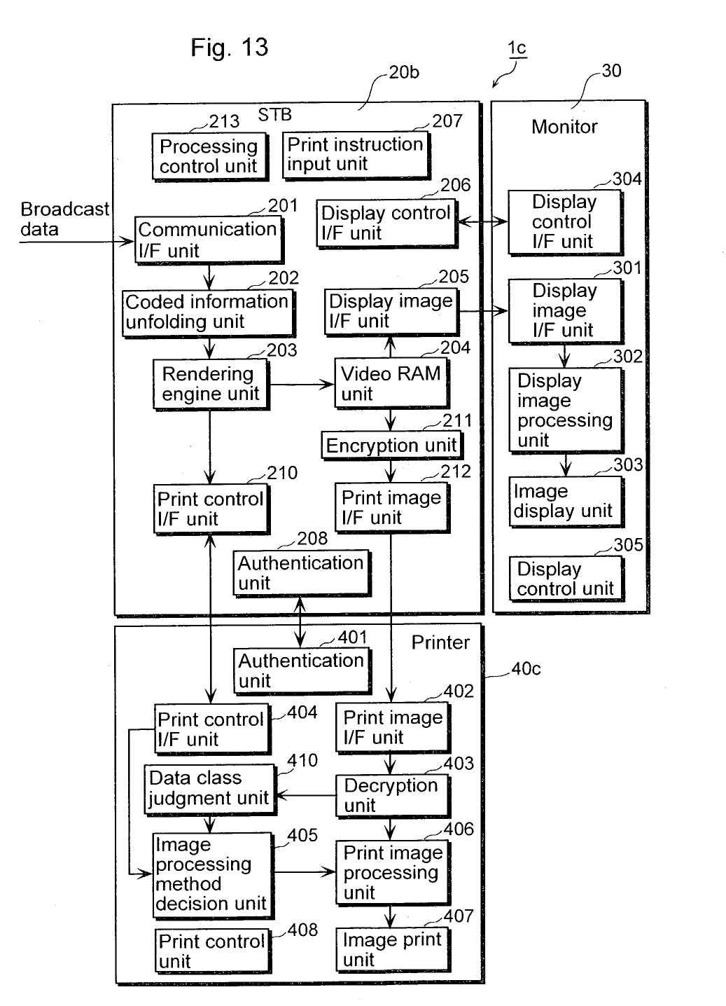

FIG. 13 is a diagram that shows a function structure of a printing system 1c according to the third embodiment.

This printing system 1c according to the third embodiment is made up of a broadcast station 10, an STB 20b, a monitor 30 and a printer 40c. In addition, in the FIG. 13, graphic representation of the broadcast station 10 is omitted. Furthermore, the same component parts of the STBs 20a and 20b, the monitor 30 and the printers 40a and 40b shown in FIG. 3 and FIG. 8 are given the same numbers and their explanations are omitted.

Here, the printing system 1a according to the first embodiment is structured to decide whether or not the image degradation processing is executed according to the contents of the print instruction information and the printing system 1b according to the second embodiment is structured to decide whether or not the image degradation processing is executed based on a rule that the degradation processing is executed if the quality of the image data is higher than the predetermined level and the printing system 1c according to the third embodiment is structured to decide whether or not the image degradation processing is executed or to select the degradation method according to the type of the print data transmitted to the printer.

Incidentally, the image quality judgment unit 409 reads that the print data are the image data displayed on a TV screen and instructs the print image processing unit 406 to execute the degradation process across the board. However, when the print data are data written in the BML (Broadcast Markup Language) format, if the degradation processing is executed to the text part, inconvenience that the letters become difficult to read or unable to read occurs.

In this case, when the print data are the data written in the BML (Broadcast Markup Language) format, it is thinkable to cause a branch to instruct to not execute the degradation processing to the text part only. As for judgment methods, a method for adding an information tag that shows the kind of the print data to the data transmitted from the STB 20b to the printer 40c and for judging by the information tag, a method for judging by the file extension of the data and the like are thinkable.

Additionally, in the print data written by the BML format, the text data are mixed with the image data such as JPEG.

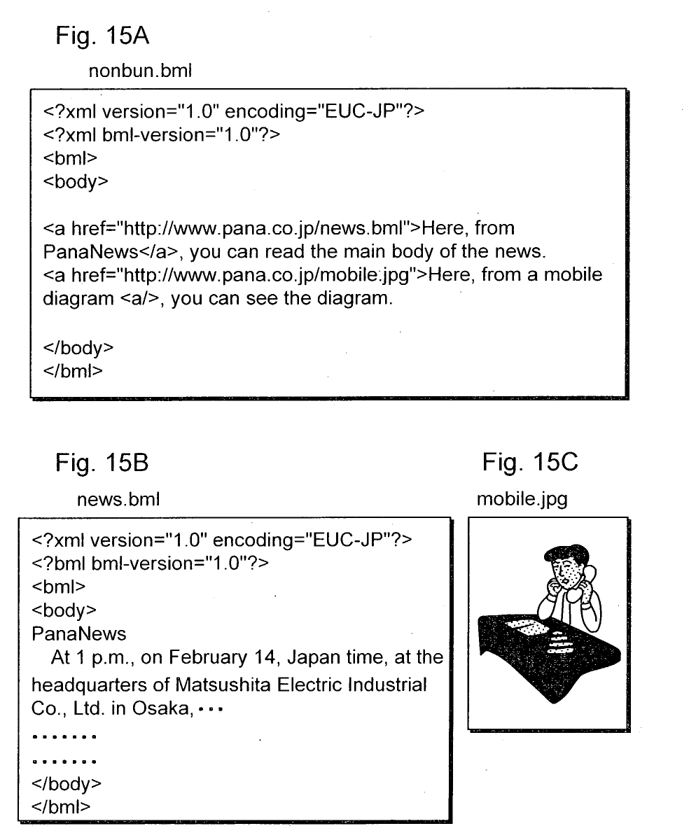

As for examples shown in the FIG. 15, FIG. 15A and FIG. 15B are text data while FIG. 15C is image data.

The text data are not objects for image degradation by the pixel skipping and the like differing from the image data. The reason is the inconvenience that the text data become unreadable by the degradation. Consequently, it is thinkable to not make the text data the object of the degradation and to make only the image data the object of the degradation.

To realize this, when the print data are written in the BML format, a data class judgment unit 410 distinguishes the image data only such as JPEG by the extension, the data type and the like of the file and instructs the print image processing unit 406 to process to degrade the image data only.

The printer 40c is different from the printer 40b shown in FIG. 8 in the respect that the printer 40c is structured to be equipped with the data class judgment unit 410 instead of the image quality judgment unit 409 and corresponds to pull print.

This data class judgment unit 410 judge whether or not a file is the image data based on the file extension and the like out of the print data that are made up of plural files inputted and decrypted

Next, the processing that each part of the printer 40c executes is explained.

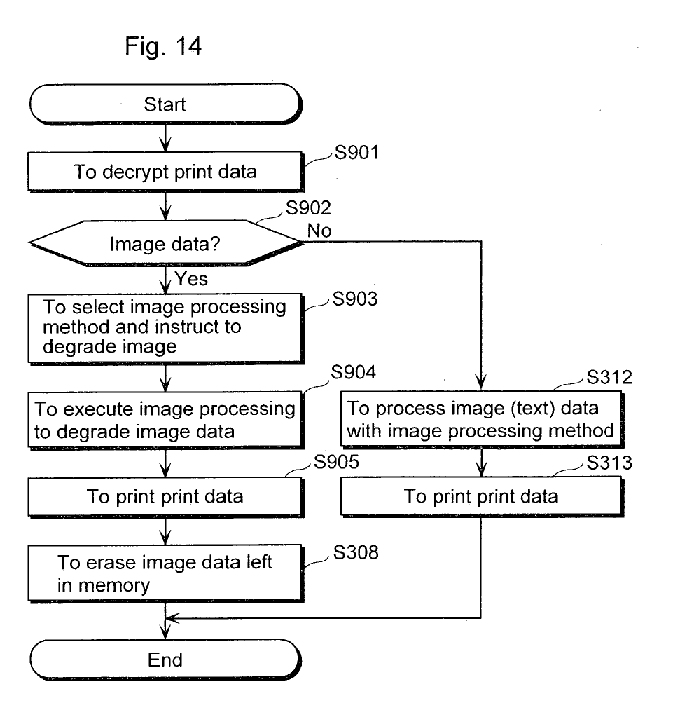

FIG. 14 is a flowchart that shows operations of processing that each part of the printer 40c shown in FIG. 13 executes.

When print data made up of plural files are inputted into the printer 40c, the decryption unit 403 decrypts the print data and transmits each file to the data class judgment unit 410 as well as the print image processing unit 406 (S901).

The data class judgment unit 410 judges whether or not the contents of the file are the image data (S902). If they are the image data, the data class judgment unit 410 informs the image processing method decision unit 405 accordingly. The image processing method decision unit 405 specifies the image processing method to degrade the image and issues an instruction to the print image processing unit 406 (S903). The print image processing unit 406 executes image processing to degrade the image data using the instructed method (S904). The image print unit 407 prints the image on a paper using the print data including the image data processed to degrade the image (S905). The following flow is same as that of FIG. 6.

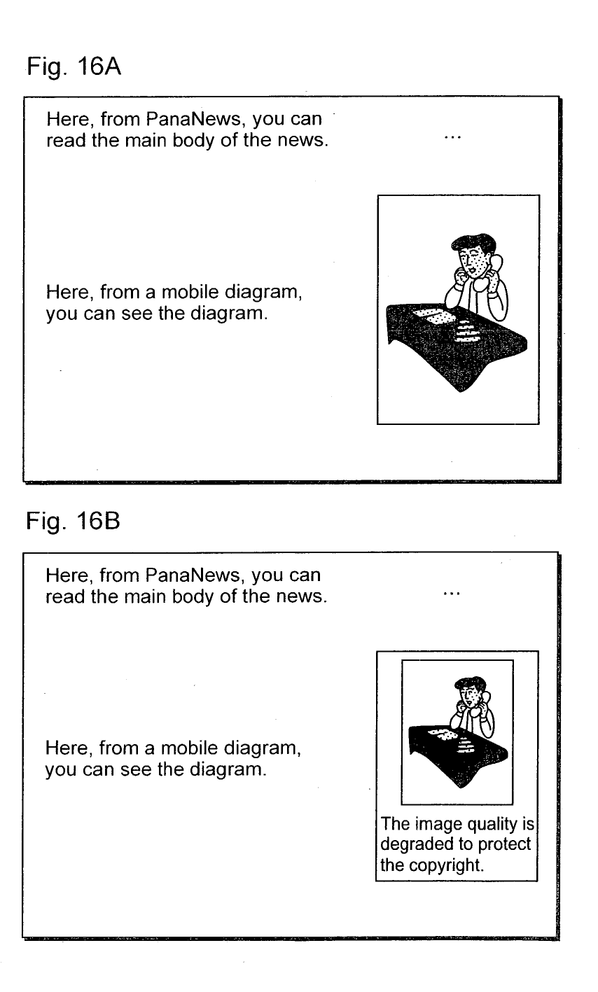

FIG. 16 is diagrams that show manner of degradation processing of an image, and particularly FIG. 16A is a diagram that shows the original image before the degradation processing and FIG. 16B is a diagram that shows the image after the degradation processing (the reduction processing) is executed only to the image part. Since the image in the print image without the degradation processing is large and therefore is of high quality so that the detail can be seen clearly while in the reduced print image the detail is unclear so that it is apparent that the image quality is degraded.

In addition, it is acceptable that the print instruction information is included in the print data written in the BML format and the printer reads the print instruction information and executes the instruction.

To be more specific, out of the print data written in the BML format, “print_control” is specified as name attribute of “meta” tag and values of “print_ok”, “print_never” and the like are specified as content distribute. Doing this, it is possible to control printing a BML document with the “meta” tag as a header.

Additionally, in the case of reducing the image, it is acceptable to instruct adding a reason such as “the image quality is degraded to protect the copyright” as shown in FIG. 16B.

With no instruction as to the image processing method, the print image processing unit 406 executes an ordinary print processing similarly to the case of the first embodiment. In this case, the original image is of low image quality, is printed in the low image quality as is and therefore there is no need to degrade the image quality. Additionally, since the processing afterwards (S307, S308) is similar to that of the first embodiment, the explanation is omitted.

As is apparent from the explanation above, the printed material that answers the intention of the author can be also acquired according to the third embodiment of the present invention.

In addition, this is not limited to the print data written in the BML format, any print data written in ML (Markup Language) format can have the similar function.

Moreover, even if the print data are written in other format than the ML format, it is good enough to define an equivalent tag to the “meta” tag.

Further, the print data are made up of plural files like the BML format, as shown in the Japanese Laid-Open Patent Application No. 2000-66867, the printer may have the structure of pull print that requests the STB to acquire the image data. In this pull print, the judgment executed at Step S902 in FIG. 14 whether or not the contents of the file are the image data is not executed based on the file extension but the printer judges that data acquired by pull print are the image data and processes to degrade the image data. By this, the effect that processes to degrade only the image data can be obtained. This is possible because of the properties of the BML format that the print data are made up of one text data and plural image data and in the one text data the link information to the image data is written.

Additionally, it is acceptable to set up the judgment unit 209 in the STB 20b and to transmit the image data from the STB 20b to the printer 40c only when the judgment unit 209 judges that the print instruction information is not “Print prohibited”.

(The fourth embodiment)

Next, a printing system according to the fourth embodiment of the present invention is explained.

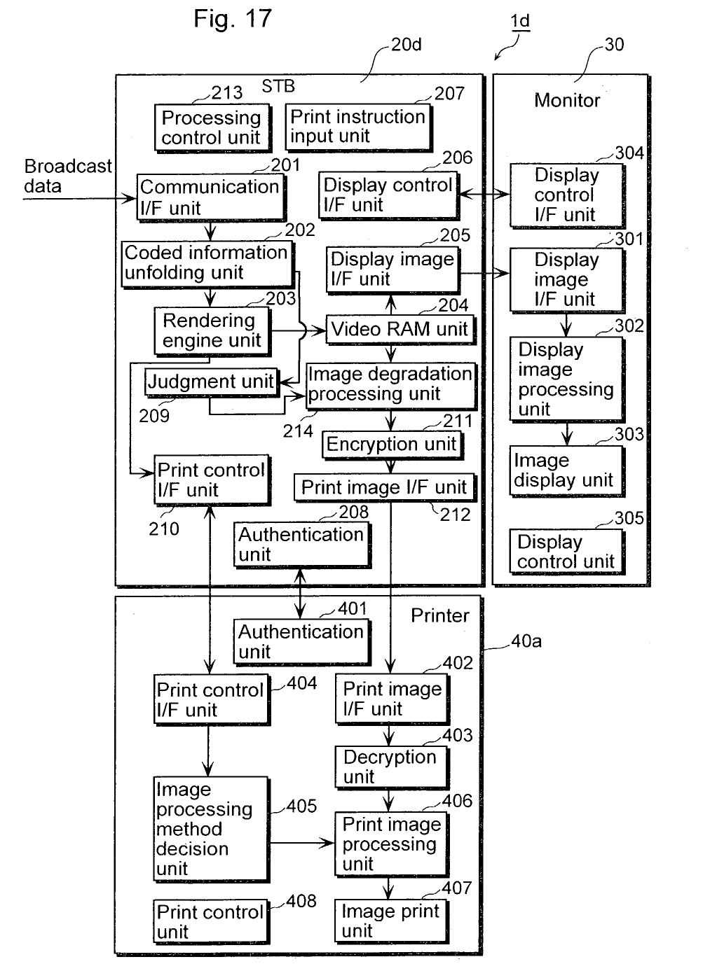

FIG. 17 is a diagram that shows a function structure of a printing system 1d according to the fourth embodiment.

This printing system 1d according to the fourth embodiment is made up of a broadcast station 10, an STB 20d, a monitor 30 and a printer 40a. In addition, in the FIG. 17, graphic representation of the broadcast station 10 is omitted. Furthermore, the same component parts of the STBs 20a and 20b, the monitor 30 and the printers 40a, 40b and 40c shown in FIG. 3, FIG. 8 and FIG. 13 are given the same number and their explanations are omitted.

Here, in the printing systems 1a˜1c according to the first˜the third embodiment, the printers 40a˜40c execute the image quality degradation processing but the printing system 1d according to the fourth embodiment is structured so that the STB 20d executes the image quality degradation processing. Additionally, the printing system 1a according to the first embodiment converts the copy control information included in the broadcast data into the print control information and uses the print control information but the printing system 1d is structured so that the print instruction information specifically for print control is separately added to the broadcast data and this print instruction information transmits an instruction to degrade the image.

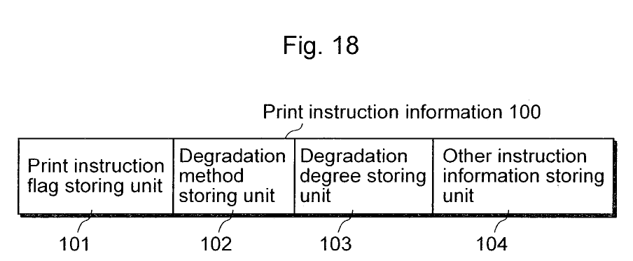

FIG. 18 is a diagram that shows a structure example of the print instruction information specifically for the print control.

This print instruction information 100 is made up of a print instruction flag storing unit 101 that stores the first flag \mathring{1}, the second flag \mathring{2} and the third flag \mathring{3}, a degradation method storing unit 102 that stores the methods to degrade the image, the degradation degree storing unit 103 that stores the degree of degradation and an other instruction information storing unit 104 that stores the other instructions. When the print instruction flag storing unit 101 stores the third flag \mathring{3}, namely “Print permitted in the case of degradation”, the instruction is stored freely in the degradation method storing unit 102˜the other instruction storing unit 104 by a copyright manager. In the degradation method storing unit 102, for example, pixel reduction by the pixel skipping and the like and image edition by the reduction of color reproducibility and the like are stored. In the degradation degree storing unit 103, for example, the degradation of the resolution to the SD image quality standard, the 50 percent degradation of the degree of the pixel skipping and the like are stored. Moreover, in the other instruction information storing unit 104, an instruction such as “Print permitted to a certain number of sheets” is stored. In addition, it is acceptable that the print instruction flag storing unit 101 is structured to store only the third flag \mathring{3}.

Receiving the print instruction information 100 transmitted by the coded information unfolding unit 202, the judgment unit 209 watches the print instruction flag storing unit 101 and, if the print instruction flag is “Print permitted in the case of degradation”, instructs the image degradation processing unit 214 to execute the image degradation processing following the information stored in the degradation method storing unit 102˜the other instruction storing unit 104.

Receiving the image degradation instruction from the judgment unit 209, the image degradation processing unit 214 executes the image degradation processing to the image transmitted by the video RAM unit 204 following the image degradation instruction and transmits the image data processed to degrade the image to the encryption unit 211. By the way, when the print instruction flag storing unit 101 indicates “Print permitted without restriction”, the rendering engine unit 203 does not transmit any instructions to the image degradation processing unit 214. In this case, the image degradation processing unit 214 does not execute the image degradation processing and lets the image data pass through.

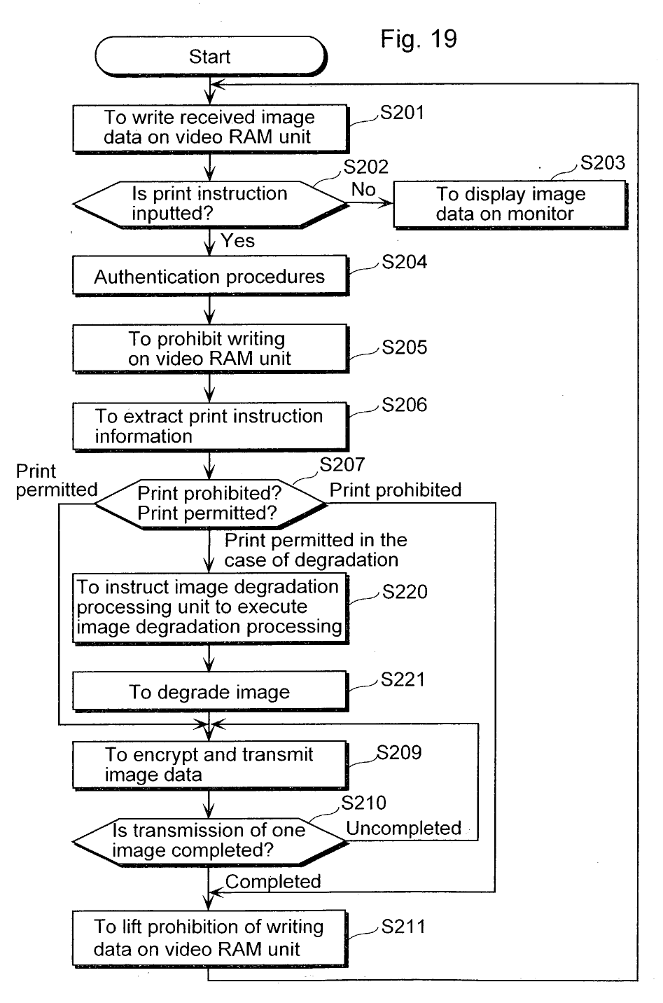

FIG. 19 is a flowchart that shows operations of processing that each part of the STB 20d shown in FIG. 17 executes. The parts corresponding to the processing in FIG. 9 are given the same numbers and their explanation is omitted.

When the print instruction flag storing unit 101 of the print instruction information 100 transmitted by the coded information unfolding unit 202 indicates “Print permitted in the case of degradation” (“Permitted in the case of degradation” at S207), the judgment unit 209 instructs the image degradation processing unit 214 to execute the image degradation processing following the information of the degradation method storing unit 102˜the other instruction information storing unit 104 (S220). Receiving the image degradation instruction from the judgment unit 209, the image degradation processing unit 214 executes the image degradation processing to the image transmitted by the video RAM unit 204 following the image degradation instruction and transmits the image data processed to degrade the image to the encryption unit 211 (S221).

As a result that the image degradation processing is executed by STB 20d in advance like this, even if the printer is an ordinary one, the image to which the degradation processing is executed is printed on a paper. In addition, when the degradation processing is executed at the part of STB, it is acceptable to omit the authentication and the encryption of the data executed between the STB and the printer because it doesn't matter that the degraded data are exploited.

By the way, the printing system 1d according to the fourth embodiment is structured to decide whether or not the degradation processing is executed according to the contents of the print instruction information 100. But it is acceptable that the printing system 1d is structured to decide whether or not the image degradation processing is executed based on a rule that the image degradation unit processing unit 214 executes the degradation processing if the quality of the image data stored in the video RAM unit 204 is higher than the predetermined level similarly to the printing system 1b according to the second embodiment and that the printing system 1d is structured to decide whether or not the image degradation processing is executed according to the type of the print data stored in the video RAM unit 204 or to select the degradation method and execute the degradation processing only to the image part by the image degradation processing unit 214 similarly to the printing system 1c according to the third embodiment.

In addition, the embodiments of the present invention describe the case of inputting the broadcast data through the satellite broadcast and the like, but the data via terrestrial broadcasting, cable or Internet does not impair the intention of the present invention. Furthermore, in the case of Internet, it is acceptable that The STB 20a and the STB 20b are structured to correspond to pull print and to execute the image degradation processing in units of pull.

What is claimed is:

1. A printing method for printing image data in a system comprising: a reception device that receives image data distributed from outside and a printing device that prints the image data transmitted from the reception device, the printing method including:
a image data acquisition step in which the reception device acquires first image data of a first image quality standard;
a degradation step for converting the acquired first image data into a second image data of a second image quality standard that is inferior to the first image quality standard; and
a print step in which the printing device prints the converted second image data.

2. The printing method according to claim 1, wherein the degradation step includes:
a conversion step in which the reception device converts the first image data into the second image data and
a transfer step in which the reception device transfers the converted second image data to the printing device, and
in the print step, the printing device prints the second image data transferred from the reception device.

3. The printing method according to claim 1, wherein the degradation step includes:
a transfer step in which the reception device transfers the first image data to the printing device and
a conversion step in which the printing device converts the transferred first image data into the second image data, and
in the print step, the printing device prints the second image data converted in the conversion step.

4. The printing method according to claim 3,
wherein in the transfer step, the reception device authenticates the printing device and transfers an encrypted first image data to the printing device after encrypting the first image data, and
in the conversion step, the printing device decrypts the first imaged data transferred from the reception device and converts the decrypted first image data into the second image data.

5. The printing method according to claim 4,
wherein the authentication technique is DTCP (Digital Transmission Copy Protection).

6. The printing method according to claim 1,
wherein the first image data are made up of plural print objects and in the degradation step, the conversion is executed for each print object.

7. The printing method according to claim 6,
wherein in the print step, the printing device acquires and prints partial data repeatedly in a pull print mode according to a print instruction from the outside and
in the pull print mode the partial data are the print objects.

8. The printing method according to claim 1,
wherein the conversion of the degradation step is changing resolution or an aspect ratio of an image indicated by the first image data.

9. The printing method according to claim 1,
wherein the first image quality standard is the image quality standard of an HD image of digital broadcast, and
the second image quality standard is the image quality standard that corresponds to an SD image of the digital broadcast.

10. The printing method according to claim 9, wherein when the first image quality standard is the HD image quality standard of the digital broadcast, the second image quality standard is converted into the SD image quality standard of the digital broadcast.

11. The printing method according to claim 1, wherein the conversion of the degradation step is processing to combine the first image data with other image data.

12. The printing method according to claim 1, wherein the conversion of the degradation step changes color information of the first image data.

13. The printing method according to claim 1, wherein the conversion of the degradation step limits a print size of the first image data to less than a predetermined size.

14. The printing method according to claim 1, wherein a mode of the conversion of the degradation step is determined by the type of the first image data.

15. The printing method according to claim 14, wherein a different mode of conversion is executed in the degradation step depending on whether the type of the first image data is an HD image format of digital broadcast, a video format or a BML (Broadcast Markup Language) format.

16. The printing method according to claim 15, wherein in the degradation step, the conversion is executed only on a picture part included in the first image data when the format of the first image data is the BML (Broadcast Markup Language) format.

17. The printing method according to claim 1 further including:
a print control information acquisition step in which the reception device acquires print control information that is information on print control distributed with the first image data and
a degradation control step for determining whether or not the conversion in the degradation step is executed based on the acquired print control information.

18. The printing method according to claim 17,
wherein a flag that indicates one of “Print permitted”, “Print prohibited” and “Print permitted in the case of below the predetermined image quality standard” is included in the print control information, and
in the degradation step, the conversion in the degradation step is executed when the flag indicates “Print permitted in the case of below the predetermined image quality standard”.

19. The printing method according to claim 17,
wherein a flag indicating “degrade the image quality standard at the time of printing” is included in the print control information, and
in the degradation control step, the conversion of the degradation step is executed when the flag indicates “degrade the image quality standard at the time of printing”.

20. A broadcast data generation device that generates broadcast data including image data that can be printed comprising:
a image data generating unit operable to generate image data;
a print control information generation unit operable to generate print control information that is information to control printing of the generated image data; and
a conversion unit operable to associate the generated image data with the print control information and to convert the image data and the print control information into the broadcast data.

21. The broadcast data generation device according to claim 20, wherein in the print control information, a flag that indicates one of “Print permitted”, “Print prohibited” and “Print permitted in the case of below the predetermined image quality standard” is included.

22. The broadcast data generation device according to claim 20, wherein in the print control information, a flag indicating “degrade the image quality standard at the time of printing” is included.

23. A program for a broadcast data generation device that generates broadcast data including image data that can be printed, the program including:
a image data generating step for generating image data;
a print control information generation step for generating print control information that is information to control printing of the generated image data; and
a conversion step for associating the generated image data with the print control information and for converting the image data and the print control information into the broadcast data.

24. A reception device that receives image data distributed from outside and outputs the image data to a printing device comprising:
a image data acquisition unit operable to acquire first image data of a first image quality standard;
a degradation unit operable to convert the first image data into a second image data of a second image quality standard that is inferior to the first image quality standard; and
an output unit operable to output the converted second image data to the printing device.

25. The reception device according to claim 24, wherein the first image data are made up of plural print objects and the degradation unit executes the conversion for each print object.

26. The reception device according to claim 25,
wherein in the print step, the printing device acquires and prints partial data repeatedly in a pull print mode according to a print instruction from the outside and
in the pull print mode the partial data are the print objects.

27. The reception device according to claim 24, wherein the degradation unit executes the conversion by changing resolution or an aspect ratio of an image indicated by the first image data.

28. The reception device according to claim 24,
wherein the first image quality standard is the image quality standard of an HD image of digital broadcast, and
the second image quality standard is the image quality standard that corresponds to an SD image of the digital broadcast.

29. The reception device according to claim 28,
wherein when the first image quality standard is the HD image quality standard of the digital broadcast, the second image quality standard is converted into the SD image quality standard of the digital broadcast.

30. The reception device according to claim 24, wherein the degradation unit executes the conversion by combining the first image data with other image data.

31. The reception device according to claim 24, wherein the degradation unit executes the conversion by changing color information of the first image data.

32. The reception device according to claim 24, wherein the degradation unit executes the conversion by limiting a print size of the first image data to less than a predetermined size.

33. The reception device according to claim 24, wherein the degradation unit executes the conversion whose mode is determined by the type of the first image data.

34. The reception device according to claim 33, wherein the degradation unit executes a different mode of conversion depending on whether the type of the first image data is an HD image format of digital broadcast, a video format or a BML (Broadcast Markup Language) format.

35. The reception device according to claim 34, wherein the degradation unit executes the conversion only on a picture part included in the first image data when the format of the first image data is the BML (Broadcast Markup Language) format.

36. The reception device according to claim 24 further comprising:
a print control information acquisition unit operable to acquire print control information that is information on print control distributed with the first image data and
a degradation control unit operable to determine whether or not the conversion in the degradation unit is executed based on the acquired print control information.

37. The reception device according to claim 36,
wherein a flag that indicates one of “Print permitted”, “Print prohibited” and “Print permitted in the case of below the predetermined image quality standard” is included in the print control information, and
the degradation control unit has the degradation unit execute the conversion when the flag indicates “Print permitted in the case of below the predetermined image quality standard”.

38. The reception device according to claim 36,
wherein a flag indicating “degrade the image quality standard at the time of printing” is included in the print control information, and
the degradation control unit has the degradation unit execute the conversion when the flag indicates “Degrade the image quality standard at the time of printing”.

39. A program for a reception device that receives image data distributed from outside and outputs the image data to a printing device, the program including:
a image data acquisition step for acquiring first image data of a first image quality standard;
a degradation step for converting the acquired first image data into a second image data of a second image quality standard that is inferior to the first image quality standard; and
an output step for outputting the converted second image data to the printing device.

40. A printing device that prints image data transferred from an external device comprising:
a image data acquisition unit operable to acquire first image data of a first image quality standard transferred from the external device;
a degradation unit operable to convert the acquired first image data into a second image data of a second image quality standard that is inferior to the first image quality standard; and
a print unit operable to print the converted second image data.

41. The printing device according to claim 40, wherein the first image data are encrypted,
the image data acquisition unit acquires the encrypted first image data after executing authentication procedures with the external device and decrypts the acquired first image data, and
the degradation unit converts the decrypted first image data into the second image data.

42. The printing device according to claim 41, wherein the authentication technique is DTCP (Digital Transmission Copy Protection).

43. The printing device according to claim 40, wherein the first image data are made up of plural print objects and the degradation unit executes the conversion for each print object.

44. The printing device according to claim 43,
wherein in the print step, the printing device acquires and prints partial data repeatedly in a pull print mode according to a print instruction from the outside and
in the pull print mode the partial data are the print objects.

45. The printing device according to claim 40, wherein the degradation unit executes the conversion by changing resolution or an aspect ratio of an image indicated by the first image data.

46. The printing device according to claim 40,
wherein the first image quality standard is the image quality standard of an HD image of digital broadcast, and
the second image quality standard is the image quality standard that corresponds to an SD image of the digital broadcast.

47. The printing device according to claim 46, wherein when the first image quality standard is the HD image quality standard of the digital broadcast, the second image quality standard is converted into the SD image quality standard of the digital broadcast.

48. The printing device according to claim 40, wherein the degradation unit is processing to combine the first image data with other image data.

49. The printing device according to claim 40, wherein the degradation unit executes the conversion by changing color information of the first image data.

50. The printing device according to claim 40, wherein the degradation unit executes the conversion by limiting a print size of the first image data to less than a predetermined size.

51. The printing device according to claim 40, wherein the degradation unit executes the conversion whose mode is determined by the type of the first image data.

52. The printing device according to claim 51, wherein the degradation unit executes a different mode of conversion depending on whether the type of the first image data is an HD image format of digital broadcast, a video format or a BML (Broadcast Markup Language) format.

53. The printing device according to claim 52, wherein the degradation unit executes the conversion only on a picture part included in the first image data when the format of the first image data is the BML (Broadcast Markup Language) format.

54. The printing device according to claim 40 further comprising:
a print control information acquisition unit operable to acquire print control information that is information on print control distributed with the first image data and
a degradation control unit operable to determine whether or not the conversion in the degradation unit is executed based on the acquired print control information.

55. The printing device according to claim 54,
wherein a flag that indicates one of “Print permitted”, “Print prohibited” and “Print permitted in the case of below the predetermined image quality standard” is included in the print control information, and
the degradation control unit has the degradation unit execute the conversion when the flag indicates “Print permitted in the case of below the predetermined image quality standard”.

56. The printing device according to claim 54,
wherein a flag indicating “degrade the image quality standard at the time of printing” is included in the print control information, and
the degradation control unit has the degradation unit execute the conversion when the flag indicates “Degrade the image quality standard at the time of printing”.

57. A program for a printing device that prints image data transferred from an external device, the program including:
a image data acquisition step for acquiring first image data of a first image quality standard transferred from the external device;
a degradation step for converting the converted first image data into a second image data of a second image quality standard that is inferior to the first image quality standard; and
a print step for printing the converted second image data.
